(19) United States
(12) Patent Application Publication
(10) Pub. No.: US 2006/0136933 A1
(43) Pub. Date: Jun. 22, 2006

(54) Server-side eventing for managed server applications

(75) Inventors: Aaron M. Jensen, Seattle, WA (US); Ameya S. Bhatawdekar, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/015,062

(22) Filed: Dec. 17, 2004

(51) Int. Cl. G06F 9/46

(52) U.S. Cl. 719/318

(57) ABSTRACT

The present invention relates to a system for generating events for a server application executing in a first process on a server computer. The system includes a server event service on the server computer executing in a second process independent of the first process. The server event service has a plurality of event handlers each event handler associated with a specified server event. The server event service is capable of receiving a server event from the server application and identifying one or more event handlers associated with the server event. The server event service then passes information related to the server event to the identified event handlers. The event handlers, in response to receiving the information related to an associated server event, generates one or more output events for the server application. In the system, the server event is generated by the server application in response to a request received from a client application on a remote client computer.

### TECHNICAL FIELD

This application relates generally to the operation of server applications and more particularly to a server-side eventing mechanism and method.

### BACKGROUND OF THE INVENTION

An event is a message sent by an application to indicate the occurrence of an action. The action could be caused by user interaction or it could be triggered by some other program logic. The events may be notifications to a user or to another application. Applications are often provided with “event handlers” to generate events to indicate the occurrence of specified actions. An event handler is a piece of code that identifies the occurrence of the action and in response generates the event and performs any associated event-specific actions; functions which are generally referred to collectively as “eventing.”

Software users often want user-specific events. That is, users want to be able to receive events that are important to them, but not receive events that are unimportant to them. Because software application developers cannot possibly foresee or support events for every possible occurrence, software applications are usually provided with only a few event handlers that support only a limited number of predetermined events that are most likely to be of interest to the average user.

In addition to predetermined events, some applications designed for use on client computers (i.e., client applications) extend the functionality of the application by allowing the development of third party event handlers. Third party developers may extend the client application functionality by writing custom event handlers that can interface with the application and therefore provide the user with custom events. The benefits of client-side eventing are that each client can tailor the event handler to that client's specific needs. While this method works for extending client applications on a single computer, extending the eventing functionality of server applications using this method has a number of drawbacks.

Server applications are applications that run on a server and typically interact with at least one client application on remote client computer systems. An example of a client-server environment is a distributed Microsoft® Project environment in which a number of client computers running Microsoft® Project applications are used in conjunction with a server running Microsoft® Project Server. Typically, a server application acts as a “middle-tier” that manages the database which contains all of the data associated with the applications. The server application often includes the bulk of the logic, while the client applications essentially provide the interface to the server application for the user.

The use of client application event handlers to provide custom eventing functionality has several drawbacks when applied to the client-server environment described above, primarily because the client applications do not have direct access to the data and may not always be connected to the server (and therefore may miss an event that occurs when not connected). One drawback is that each client application must have the same event handler. This represents a significant administrative overhead associated with maintaining updated sets of client event handlers in every client. Another drawback is that each client side event handler must have knowledge of all the other clients in order to allow events to be sent between clients. Yet another drawback is that it increases the amount of logic and memory necessary in the client applications. Yet another drawback is that a poorly designed client-side event handler could impair or disrupt the operation of the server, not only impacting the offending client but also the entire network.

In response to these drawbacks, computer scientists have tried several models for server-side eventing in a client-server environment. A first model involves building server-side eventing into the database rather than into the server application. This is a common method because most databases (as opposed to server applications) allow the development of third party event handlers. This method has many drawbacks. One drawback is that databases are complex and writing event handlers for a database is difficult and complicated. Another drawback is that the event handlers interface directly with the data, which means that poorly written event handlers have the ability to corrupt the data and even shutdown the database. Yet another drawback is that it decreases the performance of the database, which affects the entire network. Yet another drawback with this model is that changes or actions which occur in the middle tier cannot generate events because the database has no knowledge of the server application.

A second model for server-side eventing involves allowing a system administrator to create and install server-side event handlers for the server application. Drawbacks associated with this model include increased work for the system administrator to write and install each custom event handler that each client may want. Furthermore, this model requires the server application to be taken offline in order to install the new event handlers. Also, in this model, poorly drafted event handlers may decrease the performance or even cause a crash of the server application, which again affects the entire network. This is because the event handlers are integrated directly into the server application.

Both of the above-described server-side eventing models have the further drawback of not being suitable for distinguishing between synchronous and asynchronous eventing. For some events, such as validation of incoming data, synchronous events are necessary. For other events, asynchronous eventing is more appropriate.

### SUMMARY OF THE INVENTION

In accordance with the present invention, the above and other problems are solved by providing a server-side event service that allows clients to register custom, client-written event handlers with the server application without reinitializing the server application.

In accordance with other aspects, the present invention relates to a system for generating events for a server application executing in a first process on a server computer. The system includes a server event service on the server computer executing in a second process independent of the first process. The server event service has a plurality of event handlers each event handler associated with a specified server event. The server event service is capable of receiving a server event from the server application and identifying one or more event handlers associated with the server event. The server event service then passes information related to the server event to the identified event handlers. The event handlers, in response to receiving the information related to an associated server event, generates one or more output events for the server application. In the system, the server event is generated by the server application in response to a request received from a client application on a remote client computer.

In accordance with still other aspects, the present invention relates to a method for generating an event. The method includes receiving a server event generated by a server application in response to a client application request, the server application running a first computing environment on a server computer. An event handler associated with the server event is identified. The identified event handler is then initiated in a second computing environment on the server computer separate from the first computing environment. The event handler then generates an output event based on the server event.

The invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIG. 1 illustrates a server-side eventing system in accordance with an embodiment of the present invention.

FIG. 2 shows an exemplary computer system upon which embodiments of the present invention may be implemented.

FIG. 3 is another conceptual illustration of the computing architecture of another embodiment of the present invention.

FIG. 4 is a flow diagram illustrating operation characteristics for registering a new event handler for a server application in accordance with an embodiment of the present invention.

FIG. 5 is a flow diagram illustrating operational characteristics for processing a server event by a server event service in accordance with an embodiment of the present invention.

FIG. 6 is an exemplary code listing for an event configuration file that contains the event handler information for registering an event handler in accordance with an embodiment of the present invention.

FIG. 7 is an exemplary code listing for an event handler class definition in accordance with an embodiment of the present invention.

### DETAILED DESCRIPTION OF THE INVENTION

The present invention will now be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

In general, the present invention relates to a server-side event service that allows clients to register custom, client-written event handlers with the server application without reinitializing the server application. The server-side eventing service is maintained as a separate computing process in a separate environment from the server application. This allows the event service and server application to operate independently of each other.

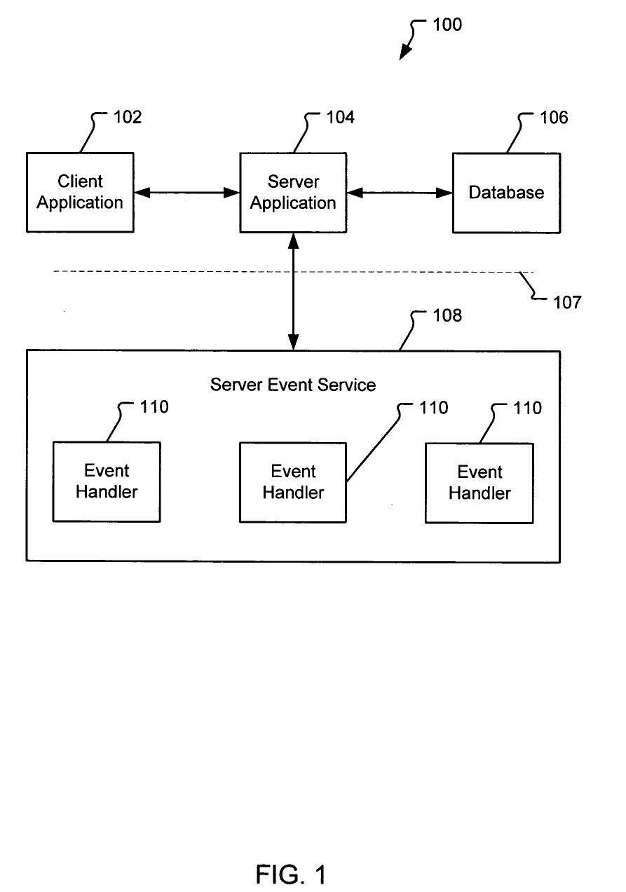

FIG. 1 depicts a high-level diagram of a server-side eventing system 100 in accordance with an embodiment of the present invention. The server-side eventing system 100 is implemented in a client-server environment in which a client application 102 is connected to a server application 104. For simplicity, only one client application 102 is shown, although one skilled in the art will understand that the server application 104 may support any number of client applications 102. One skilled in the art will recognize that the client-server environment shown in FIG. 1 may be generally applied to any type of software application. For example, the client-server environment may embody a project analysis system, such as a system of client computers executing Microsoft® Project software applications in connection with a server computer operating Microsoft® Project Server.

In accordance with an embodiment of the present invention, the client-server environment is a distributed computing environment on which each client application 102 is implemented on a separate client computing system and the server application 104 is implemented on a separate server computing system that is remote from the client computer(s). As such, the client application 102 may be connected to the server application 104 via a public communication system such as the Internet, a local area network (LAN), a wide area network (WAN) or may be directly connected via a dedicated communication link. Alternatively, the client application 102 and the server application 104 may reside on a single, stand-alone computing system.

The client application 102 has access to data on a database 106 through the server application 104. The server application 104 is the only element shown in FIG. 1 that has direct access to the database 106. In this way, the server application 104 can act as the gatekeeper for data access and thereby prevent data corruption due to access of the database by third party systems. The database 106 may be any type of database system, such as a MySQL database, a Microsoft® Access database or some other database application.

The server application 104 receives communications, such as requests and data submissions, from the client application 102. The server application 104 then processes the requests or data. The processing may involve retrieving additional data from the database 106. The processing may also involve returning data or requests to the client application 102.

In addition, the server application 104 generates predetermined server events upon the occurrence of a client request, client data submission, a server application action or any other server application situations. The server events may include data relating to the request, action, data, etc. or may include data generated by the processing performed by the server application 104. These server events are then passed to a server event service 108 which performs most if not all server-side eventing for the server application 104 as described in greater detail below.

In general, server events generated by the server application come in one of two forms: pre-events and post-events. Pre-events are server events that are generated prior to some change to the data in the database. Pre-events may be used to initiate data verification before data is stored into the database. Pre-events may also be used to initiate access-authorizing services. Pre-events are generally synchronous server events. That is, the server application 104 requires some response from the server event service 108 before the action which generated the pre-event server event can be completed by the server application 104. Depending on the response to the pre-event, the server application 104 may cancel the user request, such as when data is not verified, and may then return an error to the client application 102.

An example of a pre-event server event is a server event generated by a user request received from a client application 102 to store new data or change data in the database 106. In this situation, a server application 104 may need to verify that the user has the appropriate authority to access the data and also verify that the data is in the correct form for storage (such as within a specified range). The server application 104, in response to the request, issues a pre-event server event to the server event service 108. The server event service 108 then processes the pre-event server event using the relevant event handlers 110. After evaluating the data provided in the pre-event server event, at least one the event handlers 110 returns data through the server event service 108 to the server application 104. As pre-event server events are synchronous, the server application 104 remains idle or performs other background tasks until the response or responses are received from the server event service 108.

Post-event server events, on the other hand, differ from pre-event server events in that they may be asynchronous or synchronous—that is the server application 104 either does not need to wait for a response from the server event service 108 or does not require a response at all. Examples of actions where post-events may be used are events such as data being transmitted to a third party application in response to a server event, such as automatic generation of a materials order in response to a server event. Post-event server events may or may not require the server application 104 to wait for the server event service 108 to reply and in some cases may not even require a reply from the server event service 108 at all.

Embodiments of the present invention implement server-side eventing through the use of the server event service 108 that is independent of the server application 104. The server event service 108 can be considered a separate application in that operates in conjunction with the server application 104. This separation is illustrated by the dashed line 107 separating the server-event service 108 from the server application 104, indicating that the server-event service is in a separate computing environment. The server event service 108 maintains one or more (three are shown) independent event handlers 110. The event handlers 110 include the logic specific to particular server events. For example, one event handler 110 may be directed to transmitting an email each time a specific project database is revised. Upon receipt of a server event, the server event service 108 then determines if that server event is relevant to any event handlers 110 currently maintained. If so, the relevant event handler(s) 110 are called to process the server event and thus perform the eventing for the server event. If the server application 104 requires a reply to the server event, the server event service 108 may generate a reply on its own or may transmit a reply generated by one or more relevant event handlers 110.

The server event service 108 is capable of receiving and installing custom event handlers 110 that, through the server event service 108, perform server-side eventing for the server application 104, all independent of the operation of the server application 104. The event handlers 110 may be received from clients, for example via the client application 102, or from a system administrator of the server application. The server event server 108 receives the custom event handler 110, verifies its design, and, if it is verified, initiates the event handler 110. Upon receipt by the server event service 108 of a server event relevant to the event handler 110, the eventing functions of the event handler 110 is performed.

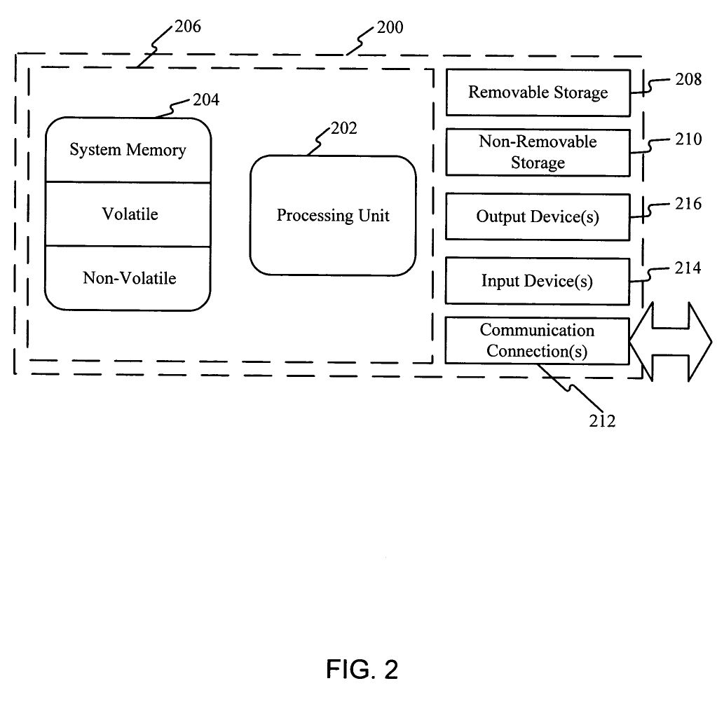

An embodiment of a suitable operating environment in which the present invention may be implemented is shown in FIG. 2. The operating environment is only one example of a suitable operating environment and is not intended to suggest any limitation as to the scope of use or functionality of the invention. Other well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

With reference to FIG. 2, an exemplary computing environment for implementing the embodiments of the present invention includes a computing device, such as computing device 200. In its most basic configuration, computing device 200 typically includes at least one processing unit 202 and memory 204. Depending on the exact configuration and type of computing device 200, memory 204 may be volatile (such as RAM), non-volatile (such as ROM, flash memory, etc.), or some combination of the two. This most basic configuration of the computing device 200 is illustrated in FIG. 2 by dashed line 206. Additionally, device 200 may also have additional features/functionality. For example, device 200 may also include additional storage (removable and/or non-removable) including, but not limited to, magnetic or optical disks or tape. Such additional storage is illustrated in FIG. 2 by removable storage 208 and non-removable storage 210. Such computer storage media includes volatile and nonvolatile, removable and non-removable media implemented in any method or technology for storage of information such as computer readable instructions, data structures, program modules, or other data. Memory 204, removable storage 208, and non-removable storage 210 are all examples of computer storage media. Computer storage media includes, but is not limited to, RAM, ROM, EPROM, flash memory or other memory technology, CD-ROM, digital versatile disks (DVD) or other optical storage, magnetic cassettes, magnetic tape, magnetic disk storage, other magnetic storage devices, or any other medium which can be used to store the desired information and which can be accessed by device 200 and processor 202. Any such computer storage media may be part of device 200.

Device 200 may also contain communications connection(s) 212 that allow the device to communicate with other devices. Communications connection(s) 212 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media.

Device 200 may also have input device(s) 214 such as keyboard, mouse, pen, voice input device, touch input device, etc. Output device(s) 216 such as a display, speakers, printer, etc. may also be included. These devices, either individually or in combination can form the user interface. All these devices are well know in the art and need not be discussed at length here.

Computing device 200 typically includes at least some form of computer readable media. Computer readable media can be any available media that can be accessed by processing unit 202. By way of example, and not limitation, computer readable media may comprise computer storage media and communication media. Computer storage media includes volatile and nonvolatile, removable and non-removable media implemented in any method or technology for storage of information such as computer readable instructions, data structures, program modules, or other data. Combinations of the any of the above should also be included within the scope of computer readable media.

Computer storage media includes, but is not limited to, RAM, ROM, EPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing device 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to herein as computer program product.

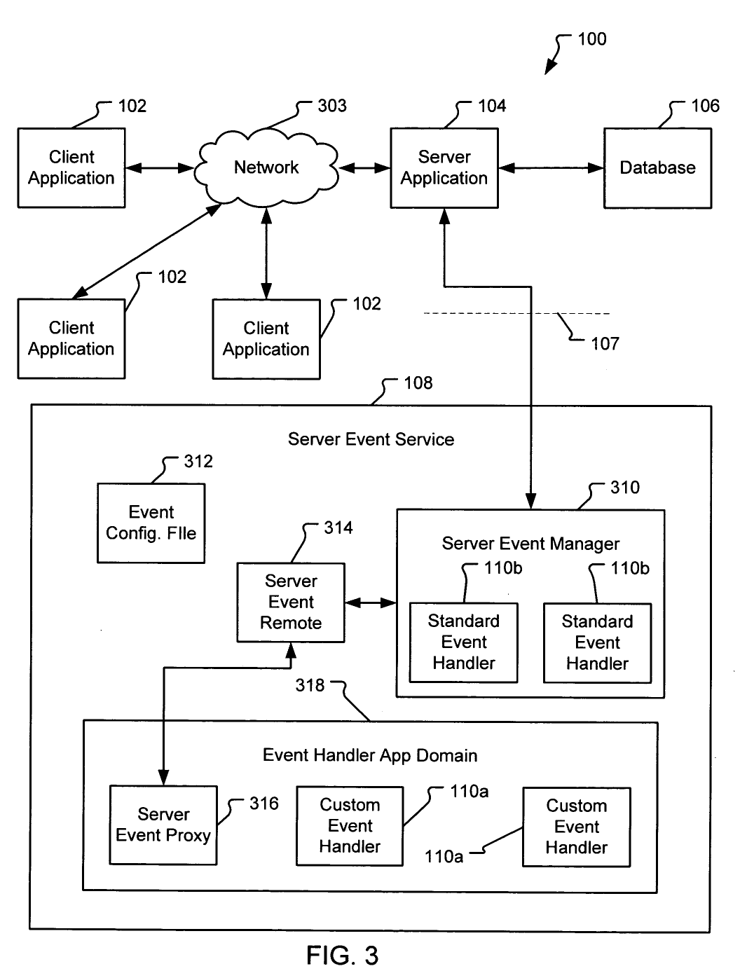

FIG. 3 is a more detailed illustration of the server-side eventing system 100 of FIG. 1 in accordance with an embodiment of the present invention. In the embodiment shown, three client applications 102 are in communication with a server application 104 via a network 303 to form a client-server system. The server application 104 is connected to a database 106 that manages the storage and retrieval data related to the server application 104. In addition, a server event service 108 is provided that provides server-side eventing for the server application 104.

The client applications 102 provides a user interface for the user to access the server application 104, and thus the data in the database 106. The client application 102 may provide some processing logic in addition to the processing logic provided by the server application 104. The client applications 102 may also be third party applications that need to access the database 106 via the server application 104.

In the embodiment described, the server application 104 provides the majority if not all of the processing logic for the client-server system. The server application 104 is capable of interfacing with the database 106, possibly via a database manager (not shown) that is provided with the database 106. In the embodiment shown, the user cannot access the database except through the server application 104.

In the embodiment shown in FIG. 3, server-side eventing is performed by a plurality of event handlers 110a, 110b executing within the server event service 108. The event handlers are divided into two types: custom event handlers 110a that may be developed by third parties after development of the server application and registered with the server event service 108 as will be described below; and standard event handlers 110b that are developed by the server application developer and provided as part of the server application functionality. The standard event handlers 110b are presumably frequently used by the average user, tested by the application developer, and considered to operate robustly with the server application. Therefore, these event handlers 110b may be treated somewhat differently than untested third party custom event handlers 110a. The class definitions or computer instructions (i.e., code) from which the event handlers 110a, 110b are initialized are stored in an event handler store (not shown). This event handler store is located either on the server itself or on a data store that is accessible to the server when the server application 104 and server event service 108 are initialized and may be co located with the store that contains the class definitions or computer instructions for the server application 104 and the server event service 108.

FIG. 3 illustrates in greater detail some of the functional modules that make up the server event service 108. The server event service 108 is a separate computing process from the server application 104 process and creates its own computing environment on the server computing system to run the modules in. In an embodiment, the server event service 108 is run as a completely separate process from that of the server application 104, while still residing on the same computing system. In that way, if any of the modules, e.g., an event handler 10a, 10b, were to crash, it does not affect the server application 104 because the server application 104 is in a separate computing environment. Alternatively, the server application 104 may reside on different computing systems which would also allow for independent operation.

In the embodiment shown in FIG. 3 the server event service 108 includes a server event manager 310. The server event manager 310 is responsible for communications between the server application 104 and the other modules of the server event service 108. The server event manager 310 includes the logic necessary to receive server events and any associated data from a server application 104 and pass them to the server event remote module 314. The server event manager 310 also contains any logic necessary to receive responses from event handlers 110a, 110b (either directly or indirectly depending on the embodiment), perform any modifications to the responses, and transmit the modified responses to the server application 104. In an embodiment, the server event manager 310 may also include the logic for standard event handlers 110b that are provided by the server application developer.

In an alternative embodiment, the server event manager 310 may be implemented as part of the server application 104. In the alternative, the server event manager 310 performs the same tasks, communicating between the server event server 108 and the server application 104 via the server event remote 314, which is the remote access point of the server event service 108. When implemented as part of the server application 104, the standard event handlers 10b are completely independent of the server-event service 108. The standard event handlers 110b may then generate the server events that are received by the server event service 108.

The server event remote 314 handles communication between the server event manager 310 (whether it is implemented in the server event service 108 as shown in FIG. 3 or alternatively implemented in the server application 104 as described above) and the event handler domain 318. The server event remote 314 is further responsible for managing the event handler configuration of the server event service 108. Upon initialization of the server event service 108 or upon notification of a configuration change, the server event manager 310 sends a request to the server event remote 314 to initialize the custom event handlers 110a for the application server 104. In response, the server event remote 314 parses a configuration file 312 and creates a separate application domain 318, which can be considered a process within the process of the server event service 108, for the custom event handlers 110a. In the case of a configuration change, the server event remote 314 first closes the existing application domain 318. The event configuration file 312 contains a listing of all event handlers that should be operating for the server application 104. Each custom event handler 110a identified in the configuration file 312 is initialized by the server remote service 314 into the newly created application domain. The separate application domain provides a logical separation between the server event manager 310 process(es) and the process which contains the potentially unstable custom event handlers 110a.

The server event proxy 316 is a module that resides in the application domain 318 with the custom event handlers 110a. In an embodiment, the server event proxy 316 is the means by which the server event remote 314, which is outside the event handler application domain 318, can cause the event handlers 110a to be initialized within application domain 318 and then communicate with the initialized event handlers 110a. The server event proxy 316 can be accessed by the server event remote 314 and contains the logic necessary to receive requests directed to custom event handlers 110a within the event handler domain 318, identify the event handler 110a within the application domain 318, pass the request to the identified custom event handler 110a and, subsequently pass the response from the event handler 110a back to the server event remote 314. In an alternative embodiment, the standard event handlers 110b may also be instantiated in a separate application domain or in the same application domain 318 as the custom event handlers 110a.

The event configuration file 312 contains information related to the event handlers 110a necessary for the server event service 108 to call the appropriate event handler 110a upon the occurrence of a specific server event. This information includes the name of the event handler 110a, 110b and the location of the event handler's code that must be initialized. In addition, the configuration file 312 may include an identifier of whether the event handler 110a, 110b is a pre-event event handler or a post-event event handler, whether the event handler 110a, 110b is asynchronous or synchronous and in what order the event handlers 110a, 110b are supposed to be executed in. The event configuration file 312 is shown as FIG. 3 as part of the server event service 108. In some embodiments the event configuration file 312 may be stored in a remote location and accessed by the server event service 108 as necessary.

Depending on the embodiment, the server event manager 310 may read the event configuration file 312 and pass that information on to the server event remote 314. In an alternative embodiment, the server event manager 310 only passes on to the server event remote 314 the information that a configuration has changed and the server event remote 314 reads the configuration file 312.

In an object oriented computing environment, each of the client applications 102, server application 104, database 106, and server event service 108 may be comprised of one or more instantiated objects that together operate to provide the necessary functionality. For example, in a Microsoft®'s .NET framework embodiment, a server application 104 may take the form of one or more instantiated objects of the server application class or classes and the server event service 108 may take the form of one or more instantiated objects of each of the server event service module classes, i.e., one or more event handler class objects, a server event proxy class object, a server event remote object, and a server event manager object, all executing in a different environment from the server application objects. For example, a client-server system for managing construction projects in the .NET framework might have a separate instantiated project object for each project and for each resource currently being accessed by a client. In embodiments, a single server event service 108 supports all instantiated server application objects and comprises a set of instantiated server event service modules, i.e., an instantiated server event manager object, server event proxy object, event handler objects, an event configuration file, etc. instantiated in a separate computing environment from the server application objects. In an alternative embodiment, a separate server event service 108 may be created for each instantiated server event object. In yet another embodiment, there may be one server event service 108 but one server event manager object instantiated for each server application.

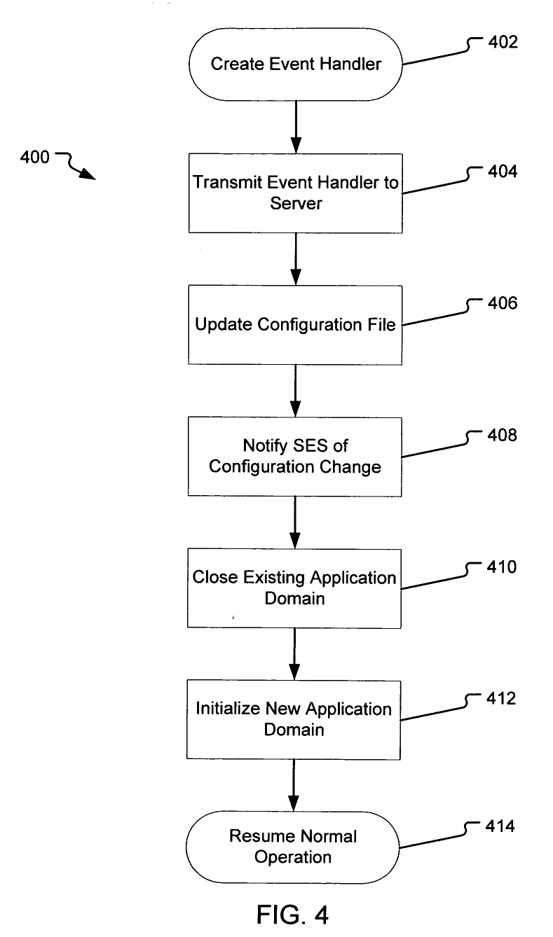

In a load-balanced multiple server (i.e., server farm) environment in which server applications 104 are instantiated on different server computers, each server computer may be provided with its own server event service 108, each of which is identical to the server event services 108 on the other server computers in the server farm. In server farm environments, embodiments of the present invention utilize one master event handler store and one configuration file 312 that are accessible by all servers. The event handler store and configuration file 312 are updated at a configuration change. The registration process, discussed below with reference to FIG. 4, then causes all server event services to access the same store and configuration file 312 so that all server event services have the same configuration at all times, even in a server farm embodiment.

In a .NET framework embodiment of the present invention, each initialized server application 104 and server event service 108 may correspond to one or more instantiated objects of a .NET class. The .NET class may be written in a programming language, such as C#, C++ or other common programming language which may be compiled and executed upon initialization.

The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

Referring now to FIG. 4 a flow diagram illustrating operational characteristics embodying a process 400 for registering a new event handler for a server application in accordance with an embodiment of the present invention. For illustration purposes, this process 400 is referred to herein as a “registration process” and described with reference to server-side eventing system 100 shown in FIG. 3. As such, the registration process 400 is described herein according to an exemplary embodiment as being performed by the various components of the server-side eventing system 100, which are described with reference to FIG. 3 using the same reference numerals and terminology. The registration process 400 is suitable for any event handler that can be registered with the event server 108. Thus, in the embodiment shown in FIG. 3, custom or standard event handlers 110a, 110b may be registered. In alternative embodiments wherein the server even manager 310 is implemented in the server application 104, only custom event handlers 110a may be registered.

The registration process 400 is performed using an operational flow beginning with a create event handler operation 402 and ending with a resume processing operation 414. In the create event handler operation 402, an event handler 110 is written to generate an event in response to a server event being received by the server event service. In an embodiment, it is anticipated that the event handler 110 is developed by a specific user, possibly with the assistance of an event handler wizard provided with the client application 102. Alternatively, the event handler 110 may be provided by a third party, possible as a set of upgraded features extending the functionality of a pre-existing server application 104.

From the create event handler operation 401, the operational flow passes to a transmission operation 404. The event handler 110 is transmitted to the server in the transmission operation 404 where it is stored in an event handler store that is accessible to the server event service 108.

From the transmission operation 404, the operational flow passes to an update configuration file operation 406. In the update configuration file operation 406, the event configuration file 312 is updated to include information necessary to identify the new event handler 110 to the server event service 108. In one embodiment, the transmission operation 404 and the update configuration file operation 406 are also performed by the event handler developer and may also be supported or facilitated by logic in the client application.

From the update configuration file operation 406, if the server event service 108 is not active at the time of the update configuration file operation 406, then the flow stops and the new configuration will be initialized upon the next initialization of the server application 104 and sever event service 108. However, after the update configuration file operation 406, if the server event service is currently active, the operational flow passes to a notification operation 408, which notifies the server event service 108 that the configuration file 312 has been updated. The notification operation 408 may generate the notification automatically upon saving the new configuration file, or alternatively the notification may be generated by the user as part of the update configuration file operation 406. For example, a user may perform the transmission operation 404, the update configuration file operation 406, and the notification operation 408 via an event administration page that is accessible to the user. The user accesses an event administration page, and through which identifies the new event handler 110, specifying which instance of the server application and what event (including whether the event handler is for a pre- or post-event) the event handler 110 is related to, whether or not it is an asynchronous or synchronous, and where in the sequence of event handlers 110 the newly added event handler 110 should be executed.

In one embodiment of the notification operation 408, the server event manager 310 is notified of the change and it subsequently notifies the server event remote 314 that a configuration change has occurred. In response the server event proxy 316 reads the information in the event configuration file 312. In another embodiment, the server event manager 310 is notified in the notification operation 408 and it reads the configuration file 312 and passes on the information from the configuration file 312 to the server event remote 314 as part of a request to initialize a new application domain.

After the notification operation 408, the operational flow passes to a close existing application domain operation 410. The close domain operation 410 closes the currently existing application domain 318 including the closing of all event handlers 110a and the server event proxy in the application domain. The closing of the existing application domain 318 does not occur immediately, but is delayed until an appropriate point is reached in the event cycle, for example, in between the servicing of server events. Because the existing application domain 318 is in a separate process within the separate process of the server event service, closing the application domain 318 does not affect the operation of either the server application 104 or the server event manager 310, except possibly to delay the processing of some of the server events. These server events are queued within the server event manager 310 until the new application domain 318 can be initialized in the following initialize new application domain operation 412.

In the embodiment shown, the initialize new application domain operation 412 follows the close operation 410. In alternative embodiment, the two operations 410, 412 may occur concurrently or the initialize new application domain operation 412 may even precede the close domain operation 410 to reduce the amount of delay engendered by the configuration changed, assuming the server resources can support the concurrent existence of the two application domains 318 for a period of time.

The initialize new application domain operation 412 (the “initialize operation 412” for short) involves the server event remote 314 using the information in the event configuration file 312 to initialize the registered event handlers 110 in the new application domain 318. In one embodiment, this includes first initializing the new application domain 318 and then initializing the server event proxy 316 to allow the server event remote 314 to interact with the new application domain 318. Next, each event handler 110 is identified by its corresponding information in the event configuration file and, via the server event proxy, initialized in the new application domain 318.

After the new application domain 318 is initialized with all the event handlers, the operation flow terminates in a resume processing operation 414. The server event service 108 resumes and any queued server events are processed.

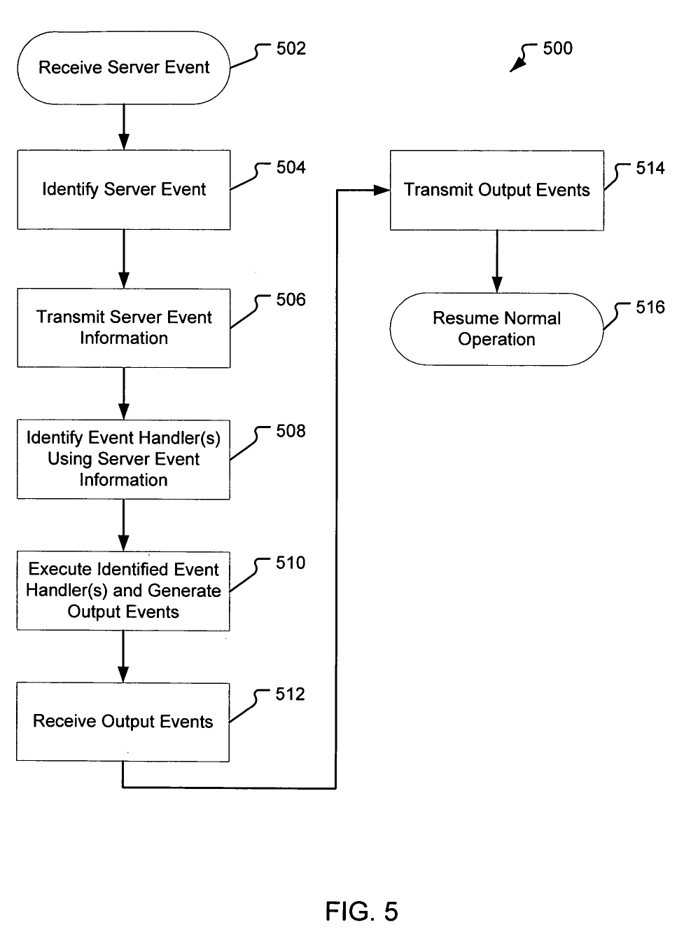

FIG. 5 shows the operational flow for processing 500 a server event by a server event service 108 in accordance with an embodiment of the present invention. Operational flow begins when a server event is received by the server event manager in a receive server event operation 502 and ends with a resume normal processing operation 516. In the receive server event operation 502, the server event may or may not be temporarily stored in a buffer or written to a log file when it is received. In one embodiment, this communication is performed using the .NET framework's remoting protocol, as the server event service 108 is in a different process (remote) than the server application 104.

After receipt, an identification operation 504 is performed by the server event manager that determines the relevant information about the server event such as the event type (e.g., a save data request event), whether the event is a pre-event or a post-event, etc.

This information is then passed from the server event manager to the server event remote 314 and subsequently to the server event proxy 316 in a transmit event operation 506. In one embodiment, the communication between the server event remote 314 and the server event proxy 316 is again performed using the .NET framework's remoting protocol, as the server event proxy 316 is in a different process (remote) than the server event remote 314.

The server event proxy 316 then performs a comparison operation 508 to identify, using the received event information, the appropriate event handlers 110 that relate to that event. The server event proxy 316 contains the information that maps the event names and event information provided in the transmission operation 506 to specific event handlers 110. The event server proxy 316 parses the information received and compares it to the information previously obtained from the event configuration file 312 to identify the appropriate event handler 110 or event handlers 110 that relate to the server event, if any, and what sequence to execute the event handlers 110 if there is more than one event handler 110 associated with the event.

After comparison operation 508, operational flow passes to an execution operation 510. In the execution operation 510 the identified event handler(s), if any, are executed in the proper sequence by passing some or all of the event information to the identified event handler(s) 110. In a NET embodiment, this involves calling one or more function members, or methods, of the instantiated event handler objects and passing some or all of the event information as arguments in the function calls. In the execution operation 510, the event handlers 110 perform their called methods using the provided information to generate output events as they were designed. These output events may cause specific notifications to be sent, such as to identified users via e-mail, or may cause certain data in the event information to be sent to a user or to another application. Output events may also be directed to the server application 104, for example, directing the server application 104 not to accept a data element because it is outside of some predetermined range of values identified in the event handler 110.

After the event handlers 110 perform their methods and generate their output events in the execution operation 510, operation flow passes to a receive output events operation 512. In that operation 512, any output events are passed to the server event proxy 316 for transmission out of the application domain 318. If multiple event handlers 110 were called, the transmission of output events occurs in the same sequence in which the event handlers 110 were called so that output from a later called event handler 110 does not somehow get transmitted ahead of any earlier called event handlers 110.

After the receive output events operation 512, operational flow then passes to a second transmission operation 514. The server event proxy 316 transmits the received output events, again in sequence, in the second transmission operation 514. In the second transmission operation 514, each output event is transmitted to the server event remote 314, which subsequently passes the output events on to the server event manager. The server event manager 310 then transmits the output events to the appropriate application (i.e., the client application 102, the server application 104, the database 106, or some other application (not shown) such as an email application) depending on the destination of the output event. The server event manager 310 may also perform some processing on the output events as necessary to ensure they are in the form expected by their destinations. For example, some processing of output events directed to the server application 104 may be necessary such as interpreting the output event and raising a cancel or proceed with action flag needed by the server application 104. The transmission operation 514 terminates the event handling operational flow and passes the flow back to the normal operation in resume normal processing operation 516. After the transmission operation 514, the server event service resumes a waiting mode in which it awaits the next server event or indication of a configuration change.

In the .NET embodiment described above, all communications between the event handlers 110 and the computing environment exterior to the server event service 108 must go through both the server event proxy 314 and the server event manager 310 because of the nested separate processes created to insulate the server application's 104 process from any errors occurring in the process executing the event handlers 110. However, in alternative embodiments the server event proxy 314 is able to transmit some of the output events directly to other applications, e.g., e-mail or other software applications, without going through the server event manager 310.

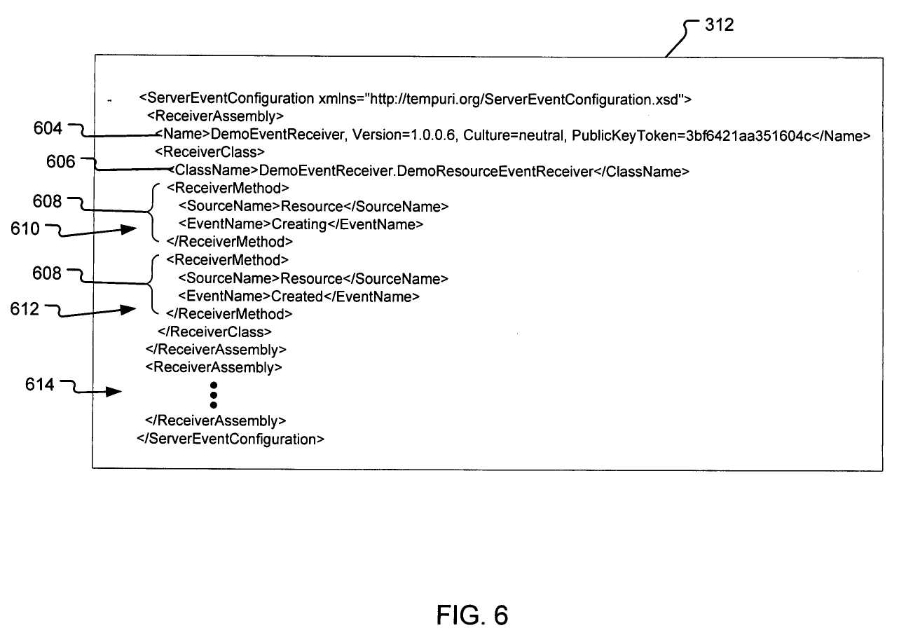

FIG. 6 is an exemplary code listing for an event configuration file 312 for use in registering an event handler 110 in accordance with an embodiment of the present invention. The event configuration file 312 is written in .XML but any programming language or data system may be used. The event configuration file 312 in FIG. 6 is for use with a .NET embodiment of the present invention.

The event configuration file 312 in FIG. 6 contains configuration information for one event handler named “DemoEventReceiver”. The configuration information for the event handler 110 includes a name 604, DemoEventReceiver, for the event handler and an event assembly identifier 606 “DemoEventReceiver:DemoResourceEventReceiver” that identifies the code (sometimes referred to as a class definition) for the DemoEventReceiver event handler. In alternative embodiments, the event assembly identifier 606 may be a file name, path name or any other identifier that can be interpreted by the server event proxy to initialize or execute event handler code.

The event configuration file 312 may also include for each event handler method information 608 for each method of the event handler. The method information 608 may include what resource (in this embodiment a resource identifies a particular instance of a server application so that the method is associated with that instance and not any other instances of the same server application) and what server event to associate the method with.

In the embodiment shown, the configuration file 312 lists two methods for the DemoEventReceiver event handler, each method having its own method information 608. In the first method 610, the method information 608 identifies that the method should be called for “resource” server applications whenever the server application generates a “Creating” server event. For the second method 612, the method information 608 identifies that the method should be called for “resource” server applications whenever the server application generates a “Created” server event.

The method information 608 allows different methods of the event handler to be associated with different resources and different server events within the designated resources. Therefore, an associated server event, such as “Creating” or “Creating” in the example of FIG. 6, indicated by the method information 608 may be associated with all server applications, such as all resource server applications as in the example. Alternatively, an event handler method can be associated with specific type of server application or only a server application operating on data associated with a specific project or set of data. For example, in a .NET embodiment of a project management server application, each instantiation of the project management application may be associated with a different project, resource, or user. The event configuration file 312 may indicate with the method information 608 that a specific event handler method is to be associated only with server events related to a specified project or resource. The method information 608 may be even more specific and identify a specific field of data (such as a field of data associated with a calculated completion date) for a specific project (the Denver Yard project) and a specific server event (completion date changed due to new data being submitted to the database). The corresponding event handler method, then, may include logic to inspect the newly changed date and generate an output event if the date is later than a predetermined date or the event handler method may be designed to notify a specific user of any changes to this date. Thus, in embodiments of the present invention, custom event handlers may be developed with one or more methods that may be associated with any granularity of server events that are supported by the server application.

Other information that may be included in the event configuration file 312 include the sequence in which the event handlers are to be executed. In FIG. 6, the sequence is determined by relative location within the configuration file such that the DemoEventReceiver event handler is first in the sequence and the following event handler 614 would be second. The event configuration file may also contain an identifier that identifies whether an associated server event is a pre- or post-event, and an identifier identifying whether a post-event is a synchronous or an asynchronous event.

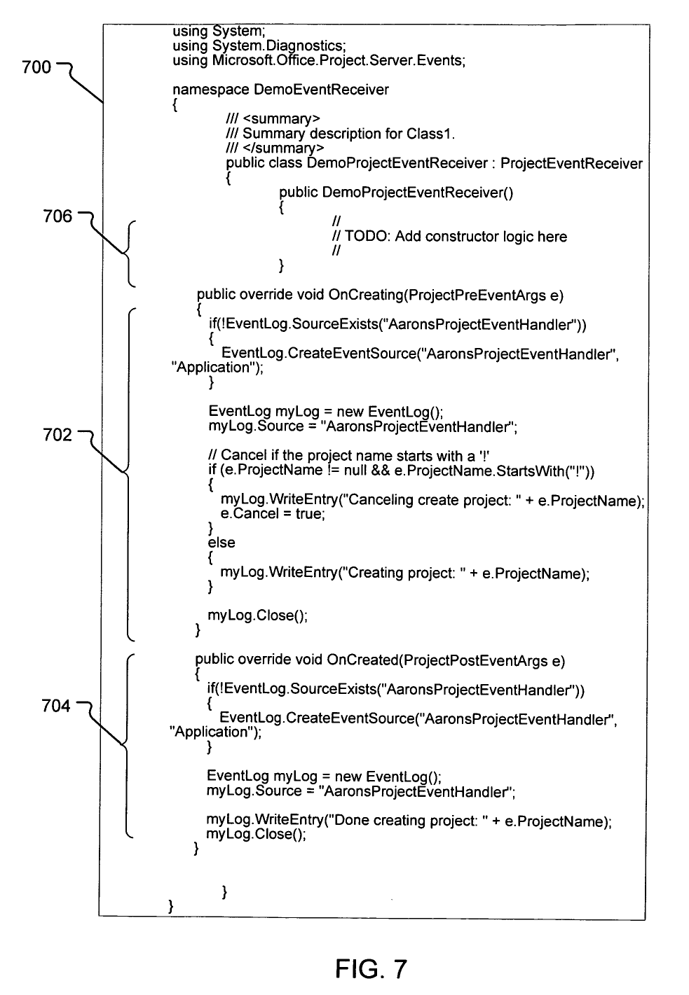

Turning now to FIG. 7, an exemplary code listing for an event handler class definition 700 is shown in accordance with an embodiment of the present invention. The event handler class definition 700 is written in C# for a .NET framework embodiment of the present invention and corresponds to the event handler information provided in FIG. 6. The C# file may be precompiled or compiled at runtime to instantiate an object of the event handler class. The event handler class definition 700 follows the well-known .NET conventions for providing the necessary information related to the class, such as class name, necessary base classes, variable definitions, etc. The event handler class definition 700 includes code for each of the methods 702, 704 that the event handler class can perform following the well-known .NET and C# programming conventions. The code 702, 704 contains the logical operations that the event handler uses to analyze the data provided by the server event proxy and, based on that analysis, generate output events. The simple exemplary event handler shown here includes that writes information to a log and generates a cancel output event in the event that a open project server event is received for projects with names starting in “!”. The code also provides space 706 for, although it does not explicitly include, constructor code for use when instantiating an object of the class, which is also well know in the art. This event handler class would be associated with an open project pre-event server event in the configuration file.

While the invention has been particularly shown and described with reference to preferred embodiments thereof, it will be understood by those skilled in the art that various other changes in the form and details may be made therein without departing form the spirit and scope of the invention. For example, the components and structure of the server-side eventing system 100 embodied in FIGS. 1 and 3 are exemplary embodiments of the present invention. Other embodiments are contemplated.

What is claimed is:

1. A system for generating events for a server application executing in a first process on a server computer comprising:
a server event service on the server computer executing in a second process independent of the first process, the server event service having a plurality of event handlers each event handler associated with a specified server event, the server event service receives a server event from the server application, identifies one or more event handlers associated with the server event, and passing information related to the server event to the one or more associated event handlers; and
in response to receiving the information related to a server event, each of the one or more event handlers generating one or more output events;
wherein the server event is generated by the server application in response to a request received from a client application on a remote client computer.

2. The system of claim 1, wherein the server event service comprises:
a server event manager module, the server event manger module providing a communication link between the event handlers executing in the second process and the server application executing in the first process.

3. The system of claim 2, wherein the event handlers are executed as a third process, the third process within the second process, the third process independent of the process executing the server event manager and the system further comprises:
an event manager proxy in the third process providing a communication link between the server event manager executing in the second process and the event handlers executing in the third process within the second process.

4. The system of claim 1, wherein the server event service is capable of receiving and initiating new event handlers associated with different server events without interruption of the first process.

5. The system of claim 1 further comprising:
an event configuration store that contains information that identifies each event handler and associates each event handler with at least one server event.

6. The system of claim 3 further comprising:
an event manager remote that initiates the third process and provides the communication link between the server manager proxy and the server event manager.

7. The system of claim 1, wherein the server application comprises:
a server event manager module, the server event manger module providing a communication link between the server event service executing in the second process and the server application executing in the first process.

8. The system of claim 7, wherein the server event service comprises:
a server event remote, the server event remote providing a communication link between the event handlers executing in the second process and the server event manager module in the first process.

9. The system of claim 8, wherein the event handlers are executed within a third process, the third process within the second process and the system comprises:
a server event proxy in the third process providing a communication link between the server event remote executing in the second process and the event handlers executing in the third process within the second process.

10. A computer-readable medium having stored thereon a data structure, comprising:
a first data field identifying an event handler assembly;
a second data field identifying a first method of the event handler assembly;
a third data field identifying a server event that is associated with the first method of the event handler assembly;

11. The computer-readable medium of claim 10, wherein the data structure further comprises:
a fourth data field identifying a server application that is associated with the first method of the event handler assembly.

12. The computer-readable medium of claim 10, wherein the data structure further comprises:
a fifth data field identifying specific data managed by the server application that is associated with the first method of the event handler assembly.

13. The computer-readable medium of claim 10, wherein the data structure further comprises:
a plurality of first data fields in a sequence, the sequence determining the order event handler assemblies will called in response to receipt of a server event by a server event service.

14. The computer-readable medium of claim 10, wherein the data structure further comprises:
a sixth data field identifying a server event type associated with the first method of the event handler assembly.

15. A method for generating an event comprising:
receiving a server event generated by a server application in response to a client application request, the server application running a first computing environment on a server computer;
identifying an event handler associated with the server event;
initiating the event handler in a second computing environment on the server computer separate from the first computing environment; and
generating, by the event handler, an output event based on the server event.

16. The method of claim 15 further comprising:
associating the event handler with the server event; and
receiving notification of a new event handler association.

17. The method of claim 15, wherein initiating comprises:
storing information associating the event handler with the server event in a configuration file stored on the server computer;
initializing the second computing environment; and
accessing the information.

18. The method of claim 15 further comprising:
initiating the server application in the first computing environment on the server computer, the server application generating the server event;
initiating a server event service in the second computing environment on the server computer;
initiating, as part of initiating the server event service, a plurality of event handlers in a third computing environment within the second computing environment;
receiving by the server event service the server event;
passing information related to the server events to one or more event handlers; and
generating, by the one or more event handlers, output events.

19. The method of claim 15 further comprising:
receiving, by the server event service, one or more new event handlers;
terminating, by the server event service, the third computing environment; and
initiating the plurality of event handlers and the one or more new event handlers in a fourth computing environment within the second computing environment.
